(19) United States
(12) Patent Application Publication
(10) Pub. No.: US 2022/0014658 A1
(43) Pub. Date: Jan. 13, 2022

(54) CAMERA MODULE WITH HEATING FUNCTION AND MANUFACTURING METHOD THEREOF

(71) Applicant: HNT ELECTRONICS COMPANY LIMITED, Seoul (KR)

(72) Inventors: Sang Ryang KIM, Asan-si (KR); Sang Ho PARK, Yongin-si (KR); Dong Hyuck KYUNG, Anyang-si (KR); Sung Ju KIM, Suwon-si (KR); Hyun Sik YU, Hwaseong-si (KR)

(21) Appl. No.: 17/296,091

(22) PCT Filed: Dec. 7, 2018
(86) PCT No.: PCT/KR2018/015572

§ 371 Date: May 21, 2021

(30) Foreign Application Priority Data
Nov. 30, 2018 (KR) 10-2018-0153172

(51) Int. Cl. H04N 5/225; G03B 17/12; G03B 17/55

(52) U.S. Cl. CPC H04N 5/22521; H04N 5/2257; G03B 17/55; G03B 17/12

(57) ABSTRACT

Provided is a camera module with a heating function. The camera module with the heating function includes a lens barrel including a lens accommodation portion in which a plurality of lenses including an outermost lens are accommodated; and a heating part formed by injecting a heating composition to the lens barrel, wherein an inner diameter of the lens accommodation portion is 50 mm or less, and the heating part is provided on the lens barrel opposed to an upper surface of the outermost lens and generates heat when power is applied.

### TECHNICAL FIELD

The present invention relates to a camera module and more particularly, to a camera module with a heating function and a manufacturing method thereof.

### BACKGROUND ART

Thanks to the dramatic development of electronic and communication technology, the miniaturization and the high performance of a camera module have been significantly advanced, and as a result, a high-performance compact camera module has been commonly mounted on portable devices such as smart phones and tablet PCs.

In addition, for various purposes, a camera module has been mounted even in various mobile means such as an automobile and a motorcycle.

Meanwhile, when the camera module is exposed to the outside, due to a temperature deviation or the like, a lens part, a lens protection window, or the like may be humid, and due to the moisture, there was a problem that the quality of a photographed image is deteriorated, a malfunction of the camera module occurs, or the life of the camera module is shortened.

To solve the problem, in the related art, a method of using a heating line such as a coil was also proposed, but there was a limit in terms of the efficiency of a manufacturing process, the competitiveness of manufacturing costs, or the like.

### DISCLOSURE

### Technical Problem

An object of the present invention is to provide a camera module with a heating function capable of implementing at least one effect of improvement of manufacturing efficiency, reduction of manufacturing costs, and extension of a product life by providing a heating function to the camera module.

Another object of the present invention is to provide a manufacturing method for a camera module with a heating function capable of implementing at least one effect of improvement of manufacturing efficiency, reduction of manufacturing costs, and extension of a product life by providing a heating function to the camera module.

### Technical Solution

According to an exemplary embodiment of the present invention, there is provided a camera module with a heating function including: a lens barrel including a lens accommodation portion in which a plurality of lenses including an outermost lens are accommodated; and a heating part formed by injecting a heating composition to the lens barrel, wherein an inner diameter of the lens accommodation portion is 50 mm or less, and the heating part is provided on the lens barrel opposed to an upper surface of the outermost lens and generates heat when power is applied.

A thickness of the heating part may be 200 μm or less and a deviation between a maximum thickness and a minimum thickness of the heating part may be 10 μm or less.

A protrusion portion may be provided on the lens barrel opposed to the upper surface of the outmost lens, wherein the protrusion portion may be provided to be spaced apart from an inner circumferential surface of the lens barrel and the heating part may be provided between the protrusion portion and the inner circumferential surface of the lens barrel.

The upper surface of the outermost lens may be in contact with a bottom surface of the protrusion portion and a bottom surface of the heating part.

The camera module may further include an electrode provided in the lens barrel to be electrically connected to the heating part; and a holder coupled with the lens barrel and provided with a power line electrically connected with the electrode. Wherein, the lens barrel may include a body portion of which the lens accommodation portion is provided on an inner circumference surface and a male screw portion is provided on an outer circumference surface; and a head portion which has a through hole provided in the center and has an outer circumferential surface having a larger diameter than an outer circumferential surface of the body portion.

Further, one end of the electrode may be provided at a lower side of the body portion and the other end of the electrode may be in contact with the heating part.

Further, one end of the electrode may be exposed to the outside of the head portion and the other end of the electrode may be in contact with the heating part.

According to another exemplary embodiment of the present invention, there is provided a manufacturing method for a camera module with a heating function including: injecting a heating composition to a lens barrel having an inner diameter of 50 mm or less; and forming a heating part by curing the injected heating composition.

Wherein, the lens barrel may include a body portion of which a lens accommodation portion is provided on an inner circumference surface and a male screw portion is provided on an outer circumference surface; and a head portion which has a through hole provided in the center and has an outer circumferential surface having a larger diameter than an outer circumferential surface of the body portion.

The injecting of the heating composition may be performed by injecting the heating composition toward a portion where the head portion and the lens accommodation portion meet inside the body portion while the lens barrel is rotated.

Further, a protrusion portion and a recess portion may be provided on the bottom surface of the head part and the heating composition injected to the recess portion may be cured to form the heating part.

The heating ink may be injected on a portion other than the heating part on a surface where the heating composition is injected while a masking is provided.

The masking may be provided by a double injection method and may be removed after injection of heating ink is terminated.

### Advantageous Effects

According to the camera module with the heating function of the embodiment of the present invention, it is possible to implement at least one effect of improvement of manufacturing efficiency, reduction of manufacturing costs, and extension of a product life by providing the heating function to the camera module.

### DESCRIPTION OF DRAWINGS

FIG. 1 is a cross-sectional view schematically illustrating a camera module according to an embodiment of the present invention,

FIG. 2 is a diagram for describing a main part of the camera module according to the embodiment of the present invention,

FIG. 3 is a diagram for describing an electrode connected to a heating part,

FIG. 4 is a diagram for describing a modification of FIG. 3,

FIG. 5 is a diagram for describing a camera module according to an embodiment of the present invention,

FIG. 6 is a diagram for describing another modification of FIG. 3,

FIG. 7 is a diagram for describing a camera module according to another embodiment of the present invention,

FIG. 8 is a diagram for describing a heating part according to an embodiment of the present invention,

FIG. 9 is a diagram schematically illustrating a modification of FIG. 8,

FIG. 10 is a diagram schematically illustrating a connection structure between a heating part and an electrode according to an embodiment of the present invention,

FIG. 11 is a diagram schematically illustrating a modification of FIG. 10,

FIG. 12 is a diagram schematically illustrating another modification of FIG. 10, and

FIG. 13 is a diagram for describing a camera module according to another embodiment of the present invention.

### BEST MODE FOR THE INVENTION

Advantages and features of the present invention, and methods for accomplishing the same will be more clearly understood from exemplary embodiments described in detail below with reference to the accompanying drawings. However, the present invention is not limited to embodiments disclosed below but may be implemented in various different forms. The present embodiments are provided so that the disclosure of the present invention may not only be complete, but also may fully provide the scope of the present invention to those skilled in the art. Throughout the whole specification, the same reference numerals denote the same elements.

It is also to be understood that the terminology used herein is for the purpose of describing embodiments only and is not intended to limit the present invention. In this specification, singular forms include even plural forms unless the context indicates otherwise. The terms ‘comprise’ and/or ‘comprising’ used herein mean that aforementioned components, steps, operations, and/or elements do not exclude the presence or addition of one or more of other components, steps, operations, and/or elements.

In addition, embodiments described herein will be described with reference to cross-sectional views and/or plan views as ideal exemplary diagrams of the present invention. In the drawings, a detail size, a shape, a thickness, a curvature, and the like of each of components are exaggerated or illustrated for an effective description of the technical contents, and the form thereof may be modified by a tolerance or the like.

Hereinafter, a configuration and an operation effect of the present invention will be described in more detail with reference to the accompanying drawings.

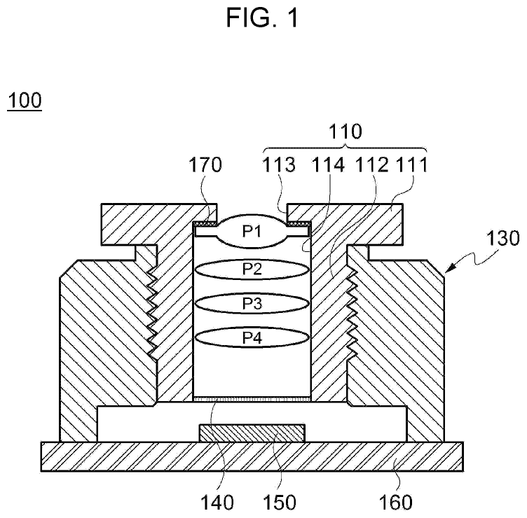

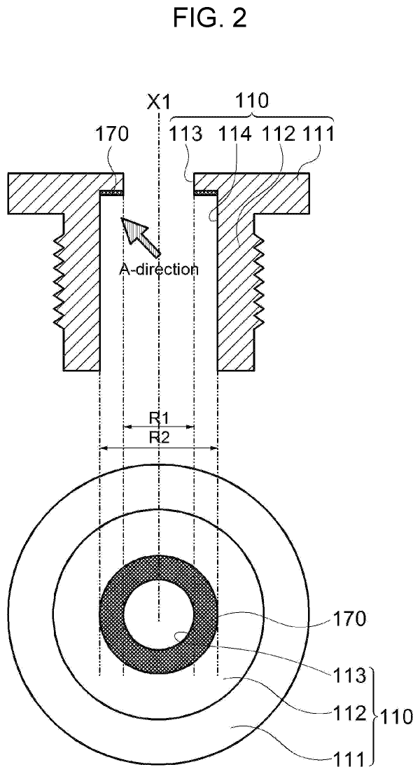

FIG. 1 is a cross-sectional view schematically illustrating a camera module 100 according to an embodiment of the present invention and FIG. 2 is a diagram for describing a main part of the camera module 100 according to the embodiment of the present invention. In one embodiment, the camera module 100 may include a lens barrel 110, lenses, a holder 130, an image sensor 150, a circuit board 160, etc., and particularly, in an embodiment of the present invention, includes a heating part 170. The heating part 170 is implemented by injecting a heating composition to a predetermined position.

In one embodiment, the heating composition may include a conductive material and a resistive material. In one embodiment, the heating composition may include at least one material selected from crystalline graphite, artificial graphite, diethylene glycol, butyl, ether, acetate, carbon black, polyester resin, and mono ethylene glycol. In addition, the heating composition may include a dispersant, an adhesive enhancer, a sedimentation preventive agent, a leveling agent, an anti-foamer, and the like.

In one embodiment, the lens barrel 110 may include a head portion 111 and a body portion 112, wherein a through hole 113 is provided in the center of the head portion 111, and a lens accommodation portion 114 may be provided on an inner circumferential surface of the body portion 112. The lens accommodation portion 114 may be accommodated with a lens group consisting of several lenses P2, P3, and P4 including an outermost lens P1, and the lenses may move in the lens accommodation portion 114 to perform an operation of automatic focus control, zoom in, zoom out, and the like. On the other hand, the shape of the lens illustrated in the drawings is illustrative, and the shapes, sizes, thicknesses, positions, distances, and the like of the lenses enable various modifications not illustrated in the drawings.

In one embodiment, the holder 130 serves to fix and support the lens barrel 110. In one embodiment, a male screw is formed on an outer circumferential surface of the body portion 112 of the lens barrel 110, and the holder 130 is provided with a receiving portion provided with a female screw corresponding thereto, so that the lens barrel 110 may be screw-coupled to the holder 130.

In one embodiment, a lower portion of the holder 130 may be coupled to a circuit board 160. Then, the image sensor 150 is mounted on the circuit board 160 to receive light passed through the lenses P1, P2, P3, and P4 and output a digital signal.

In one embodiment, an infrared filter 140 may be provided between the lenses P1, P2, P3, and P4 and the image sensor 150.

In one embodiment, the heating part 170 may be provided between the outermost lens P1 and the head portion 111.

In one embodiment, the heating part 170 may be provided on the lens barrel 110 opposed to an upper surface of the outermost lens P1.

In one embodiment, an injection or spraying process of the heating composition may be performed by an arrow direction (A-direction) illustrated in FIG. 2. When the injection process of the heating composition is completed, the heating part 170 may be formed by curing the heating composition. In this process, it is preferable that the heating composition is injected with a masking (not illustrated) in a portion other than the heating part 170. At this time, the masking is provided by a dual injection method, and the heating composition may not be left in an unnecessary portion by removing the masking after the injection of heating ink is terminated.

In one embodiment, it is preferable that the heating composition is injected in a state in which the lens barrel 110 is rotated. Accordingly, the injected heating composition is uniformly spread to implement the heating part 170 at a constant thickness and it is advantageous to lower a thickness deviation of the heating part 170 to a required level.

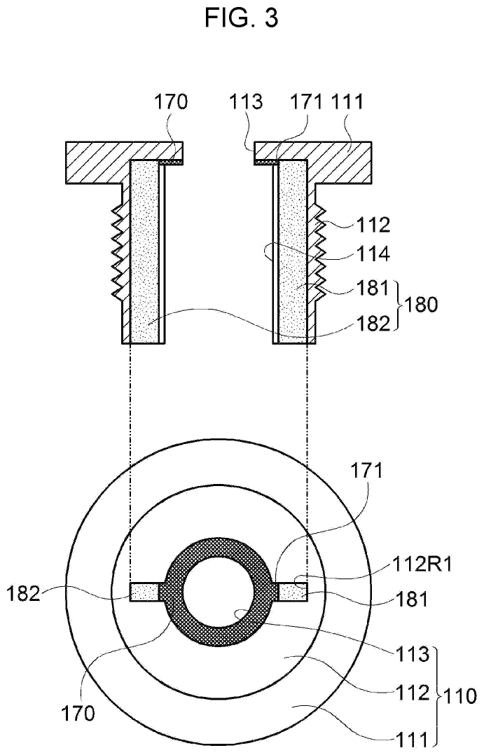

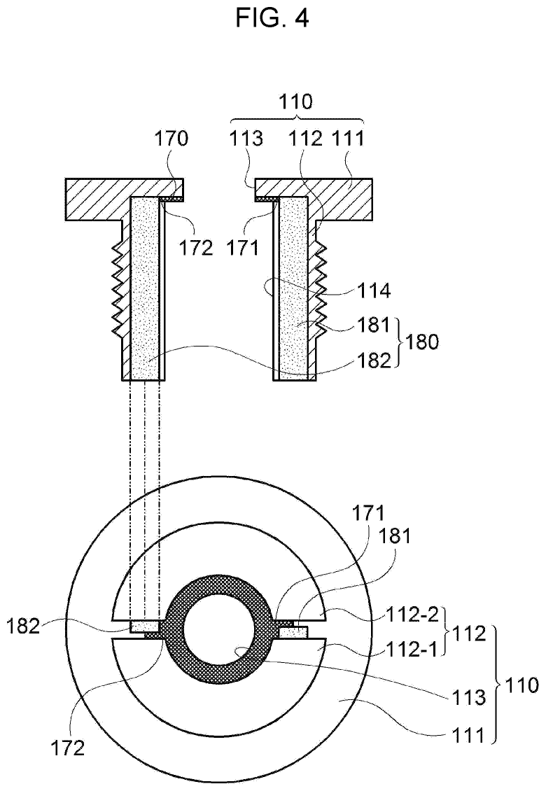

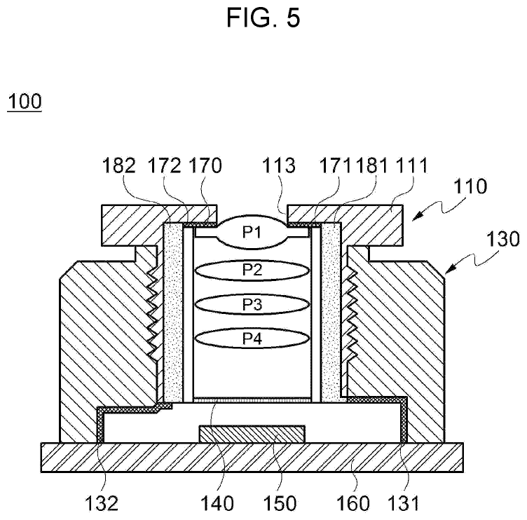

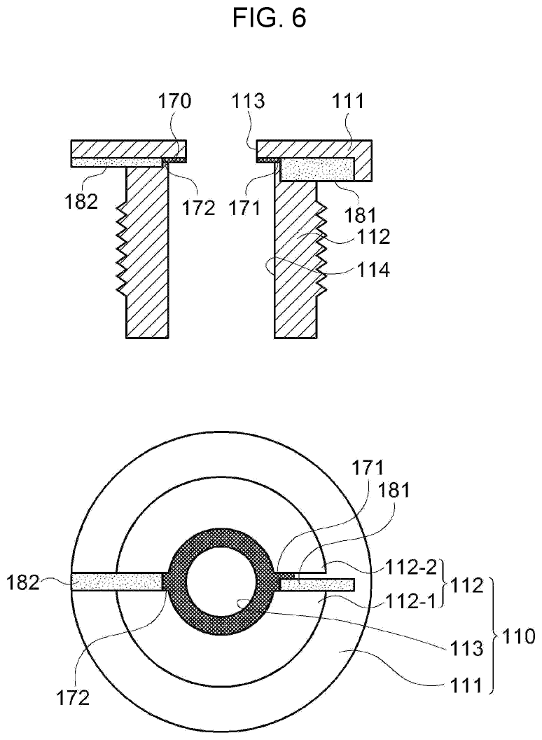

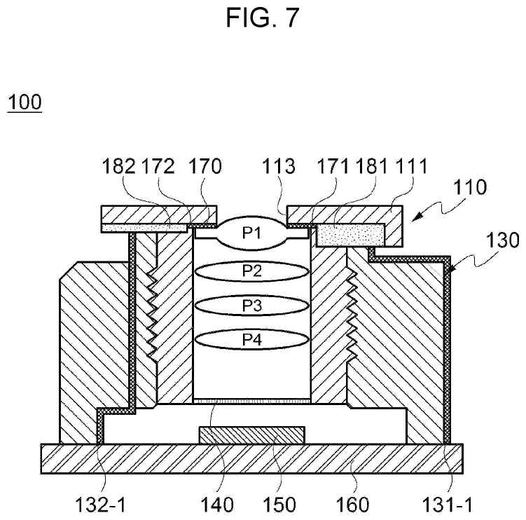

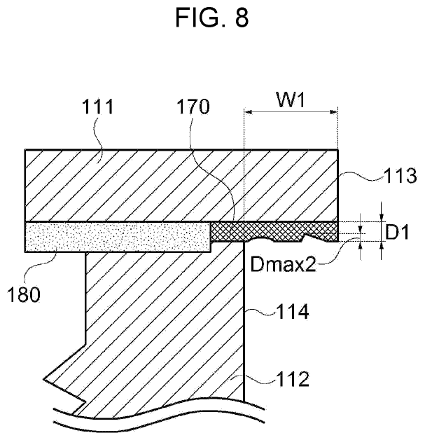

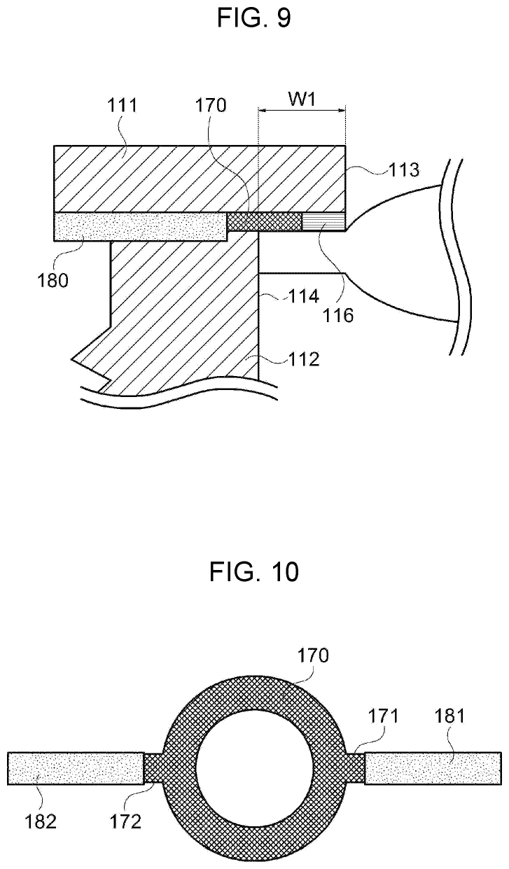

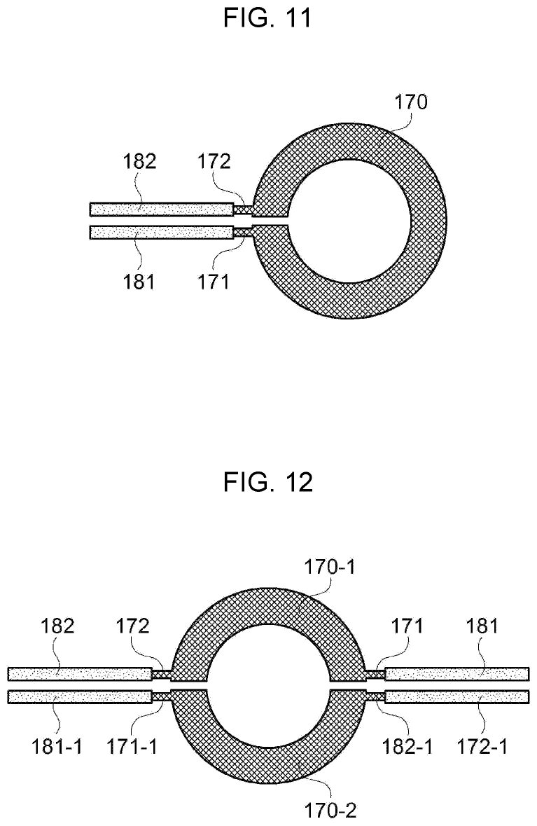

FIG. 3 is a diagram for describing an electrode 180 connected to a heating part 170, FIG. 4 is a diagram for describing a modification of FIG. 3, FIG. 5 is a diagram for describing a camera module according to an embodiment of the present invention, FIG. 6 is a diagram for describing another modification of FIG. 3, FIG. 7 is a diagram for describing a camera module 100 according to another embodiment of the present invention, FIG. 8 is a diagram for describing a heating part 170 according to an embodiment of the present invention, FIG. 9 is a diagram schematically illustrating a modification of FIG. 8, FIG. 10 is a diagram schematically illustrating a connection structure between a heating part 170 and an electrode 180 according to an embodiment of the present invention, FIG. 11 is a diagram schematically illustrating a modification of FIG. 10, and FIG. 12 is a diagram schematically illustrating another modification of FIG. 10.

Referring to the drawings, in one embodiment, a diameter R2 of the lens accommodation portion 114 is 50 mm or less. As a result, it is difficult to provide the heating composition to the heating part 170 position of the present invention by using a mechanism such as a roller. On the other hand, a method of applying the heating composition by using a brush and the like may also be considered, but this method has a limit in terms of process efficiency and precision.

In one embodiment, a diameter R1 of the through hole 113 may be appropriately determined as needed in the range of ⅕ to ⅘ of R2.

Referring to FIG. 8, when the thickness of the heating part 170 is too thick, it is difficult to maintain the flatness of the heating part 170 and the heating capability required for removing moisture is excessively exceeded. Therefore, in one embodiment of the present invention, a thickness D1 of the heating part 170 may be implemented to 200 μm or less. On the other hand, at a current art level, a process yield is relatively low in forming a thickness of less than 1 μm by injecting and spraying the heating composition.

In one embodiment, at least a portion of the upper surface of the outermost lens P1 is in contact with a bottom surface of the heating part 170. Accordingly, the heating part 170 may perform a function of providing heat to the outermost lens P1 while supporting the outermost lens P1.

In one embodiment, it is preferable that a deviation (represented by Dmax2 in FIG. 8) between a maximum thickness and a minimum thickness of the heating part 170 is 10 μm or less. If the thickness deviation of the heating part 170 is excessively large, the outermost lens P1 may be excessively distorted from a designed value, and in this case, the distortion of an optical axis may cause various problems.

In one embodiment, a width W1 of the heating part 170 may be determined to (R2−R1)/2. Here, the width W1 may mean up to the lens accommodation portion 114. A heating material may not be in direct contact with the outermost lens P1 inside the body portion 112 over the lens accommodation portion 114, and this portion may be a portion extended for connection with the electrode 180. In this meaning, in this specification, these portions are also referred to as a first extension portion 171 and a second extension portion 172, and the like.

Referring to FIG. 9, in one embodiment, a protrusion portion 116 may be provided on the lens barrel 110 opposed to the upper surface of the outermost lens P1. At this time, the protrusion portion 116 may be spaced apart from an inner circumferential surface of the lens barrel 110, that is, the lens accommodation portion 114. Accordingly, a kind of recess portion may be formed between the protrusion portion 116 and the inner circumferential surface of the lens barrel 110, and the heating part 170 may be implemented by injecting the heating composition to the recess portion.

In this embodiment, it is preferable that the upper surface of the outermost lens P1 is in contact with the bottom surface of the protrusion portion 116 and the bottom surface of the heating part 170, and furthermore, it is preferred to be in contact with at least wide area of the upper surface of the outermost lens P1. To this end, it is preferred that a step between the bottom surface of the protrusion portion 116 and the bottom surface of the heating part 170 is also minimized.

Meanwhile, the protrusion portion 116 may be made of a material with relatively larger abrasion resistance than the heating part 170. In one embodiment, since the heating part 170 is formed by injected and then curing the heating composition, when the protrusion portion 116 is implemented to be injection-molded integrally with the head portion 111, the abrasion resistance of the protrusion portion 116 may be implemented to be higher than that of the heating part 170. Accordingly, while the lenses including the outermost lens P1 are more stably supported by the protrusion portion 116, a fogging effect may be reduced by using heat generated by the heating part 170.

In one embodiment, an electrode 180 electrically connected to the heating part 170 may be provided. Further, power lines 131 and 132 electrically connected to the electrode 180 may be provided.

In one embodiment, the electrode 180 may be provided in the lens barrel 110, and the power lines may be provided in the holder 130.

Referring to FIG. 3, a first recess portion 112R1 may be formed on the body portion 112 of the lens barrel 110. In one embodiment, in the lens accommodation portion 114, the body portion 112 is recessed in an outer circumferential direction to implement the first recess portion 112R1. A first electrode 181 may be provided in the first recess portion 112R1. The first electrode 181 may be implemented as a lead line, a wire, a conductive film, a conductive paste, and the like, and may also be implemented through insert molding or a double injection method. The heating part 170 may be implemented by injecting the heating composition in a state in which the first electrode 181 is already formed in the lens barrel 110. Accordingly, a first extension portion 171 extending in a direction of the first recess portion 112R1 may be formed in the heating part 170, and while the first extension portion 171 is connected with the first electrode 181, power may be applied to the heating part 170.

Referring to FIG. 4, it is illustrated an embodiment in which the body portion 112 is divided into a first body 112-1 and a second body 112-2 and a first electrode 181 and a second electrode 182 are provided in an area therebetween.

Referring to FIG. 5, one end of the electrode 180 is provided at a lower side of the body portion 112, the other end of the electrode 180 is in contact with the heating part 170, and the first power line 131 and the second power line 132 provided in the holder 130 may be connected to lower ends of the first electrode 181 and the second electrode 182, respectively, so that a power supply line may be connected.

Referring to FIG. 6, one end of the electrode 180 is exposed to the outside of the head portion 111, and the other end of the electrode 180 may be in contact with the heating part 170. That is, the electrode 180 may not extend in a vertical direction along the body portion 112. In this case, as illustrated in FIG. 7, a first power line 131-1 may be connected to the outer circumferential surface of the holder 130 or a second power line 132-1 passing through the inside of the holder 130 may be connected to the electrode 180.

In FIGS. 10 to 12, the structure of the heating part 170, the electrode 180, and the extension portions 171 and 172 is illustrated.

Since the camera module 100 with the heating function according to an embodiment of the present invention includes the heating part 170 implemented by injecting the heating composition, it is difficult to apply the heating material with a roller, a brush, or the like, but the heating part 170 may be formed at a position where lens heating efficiency is relatively good. At this position, the outermost lens P1 may be quickly heated even if a small amount of energy is utilized. Therefore, in the camera module 100 with the heating function of the embodiment of the present invention, it is possible to implement at least one effect of improvement of manufacturing efficiency, reduction of manufacturing costs, and extension of a product life by providing the heating function to the camera module 100.

### MODES FOR THE INVENTION

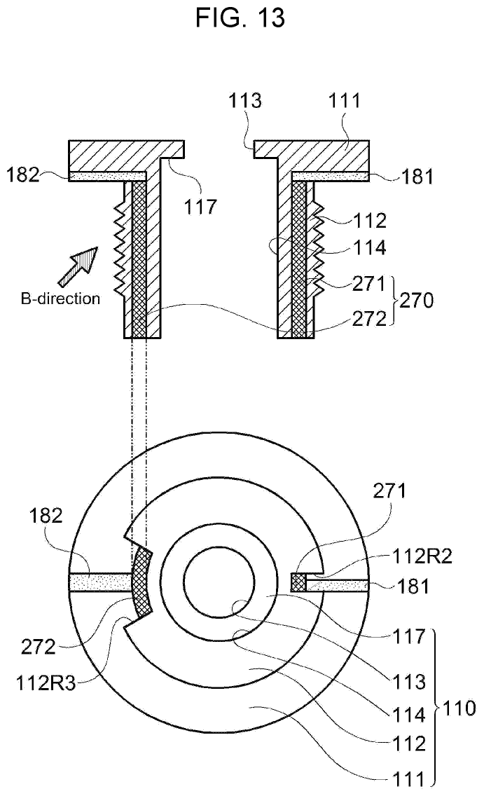

FIG. 13 is a diagram for describing a camera module 100 according to another embodiment of the present invention. In this embodiment, a second recess portion 112R2 and a third recess portion 112R3 are provided in the body portion 112, and a heating part 270 formed by injecting the heating composition therein may be provided to remove moisture.

In one embodiment, an injecting or spraying process of the heating composition may be performed by an arrow direction (B-direction) illustrated in FIG. 13. When the injection process of the heating composition is completed, the heating part 270 may be formed by curing the heating composition. In this process, the heating composition may be injected with a masking (not illustrated) in a portion other than the heating part 270. At this time, the masking is provided by a dual injection method, and the heating composition may not be left in an unnecessary portion by removing the masking after the injection of heating ink is terminated.

### INDUSTRIAL APPLICABILITY

A camera module with a heating function according to an embodiment of the present invention may be applied to various types of cameras such as smart phones, tablet PCs, black boxes for vehicles, drone-mounted cameras, CCTV cameras, and portable digital cameras.

1. A camera module with a heating function comprising:
a lens barrel including a lens accommodation portion in which a plurality of lenses including an outermost lens are accommodated; and
a heating part formed by injecting a heating composition to the lens barrel,
wherein an inner diameter of the lens accommodation portion is 50 mm or less, and
the heating part is provided on the lens barrel opposed to an upper surface of the outermost lens and generates heat when power is applied.

2. The camera module with the heating function of claim 1, wherein a thickness of the heating part is 200 μm or less and a deviation between a maximum thickness and a minimum thickness of the heating part is 10 μm or less.

3. The camera module with the heating function of claim 1, wherein a protrusion portion is provided on the lens barrel opposed to the upper surface of the outermost lens, wherein the protrusion portion is provided to be spaced apart from an inner circumferential surface of the lens barrel and the heating part is provided between the protrusion portion and the inner circumferential surface of the lens barrel.

4. The camera module with the heating function of claim 3, wherein the upper surface of the outermost lens is in contact with a bottom surface of the protrusion portion and a bottom surface of the heating part.

5. The camera module with the heating function of claim 1, further comprising:
an electrode provided in the lens barrel to be electrically connected to the heating part; and
a holder coupled with the lens barrel and provided with a power line electrically connected with the electrode,
wherein the lens barrel includes
a body portion of which the lens accommodation portion is provided on an inner circumference surface and a male screw portion is provided on an outer circumference surface; and
a head portion which has a through hole provided in the center and has an outer circumferential surface having a larger diameter than an outer circumferential surface of the body portion,
wherein one end of the electrode is provided at a lower side of the body portion and the other end of the electrode is in contact with the heating part.

6. The camera module with the heating function of claim 1, further comprising:
an electrode provided in the lens barrel to be electrically connected to the heating part; and
a holder coupled with the lens barrel and provided with a power line electrically connected with the electrode,
wherein the lens barrel includes
a body portion of which the lens accommodation portion is provided on an inner circumference surface and a male screw portion is provided on an outer circumference surface; and
a head portion which has a through hole provided in the center and has an outer circumferential surface having a larger diameter than an outer circumferential surface of the body portion,
wherein one end of the electrode is exposed to the outside of the head portion and the other end of the electrode is in contact with the heating part.

7. A manufacturing method for a camera module with a heating function comprising:
injecting a heating composition to a lens barrel having an inner diameter of 50 mm or less; and
forming a heating part by curing the injected heating composition.

8. The manufacturing method for the camera module with the heating function of claim 7, wherein the lens barrel includes
a body portion of which a lens accommodation portion is provided on an inner circumference surface and a male screw portion is provided on an outer circumference surface; and
a head portion which has a through hole provided in the center and has an outer circumferential surface having a larger diameter than an outer circumferential surface of the body portion,
the injecting of the heating composition is performed by injecting the heating composition toward a portion where the head portion and the lens accommodation portion meet inside the body portion while the lens barrel is rotated.

9. The manufacturing method for the camera module with the heating function of claim 8, wherein a protrusion portion and a recess portion are provided on the bottom surface of the head part and the heating composition injected to the recess portion is cured to form the heating part.

10. The manufacturing method for the camera module with the heating function of claim 9, wherein the heating composition is injected on a portion other than the heating part on a surface where the heating composition is injected while a masking is provided.

11. The manufacturing method for the camera module with the heating function of claim 10, wherein the masking is provided by a double injection method and is removed after injection of heating ink is terminated.

12. The manufacturing method for the camera module with the heating function of claim 7, wherein the thickness of the heating part is 200 μm or less and a thickness deviation of the heating part is 10 μm or less.
